(19) United States
(12) Patent Application Publication
(10) Pub. No.: US 2023/0294052 A1
(43) Pub. Date: Sep. 21, 2023

(54) MIXING DEVICE

(71) Applicant: TRRS MAGNATE, LLC, Manteca, CA (US)

(72) Inventor: Thomas Anthony RAYMUS, Manteca, CA (US)

(73) Assignee: TRRS MAGNATE, LLC, Manteca, CA (US)

(21) Appl. No.: 17/700,080

(22) Filed: Mar. 21, 2022

(51) Int. Cl. B01F 33/25; A47J 43/27; B01F 33/501

(52) U.S. Cl. CPC B01F 33/254; A47J 43/27; B01F 33/50111

(57) ABSTRACT

A new mixing device for mixing solids and medium- to highly viscous food ingredients with liquid in a shaker bottle. The mixing device has a generally dumbbell-shaped agitator insertable within a hand-held, shakeable container. The agitator is composed of a framework arranged to provide voids to allow for flow of liquids, powders, and other materials into and out of portions of the generally dumbbell-shaped agitator. The mixing device also has a weighted member attached adjacent to or within the center of the generally dumbbell-shaped agitator that increases the momentum of the mixing device when in operation.

### BACKGROUND

People of all walks of life use shaker bottles to mix, shake, and drink protein and other supplements. For many, it is a ritual to put their preferred supplements and liquids in a shaker bottle, shake vigorously, and drink, anticipating important health benefits. As more people become health aware and participate in exercise and sporting events, the use of shaker bottles continues to increase. Because shaker bottles are ubiquitous, it is easy to forget that their advent and popularity is relatively recent and that, therefore, design options and functionality somewhat limited. Significantly, the increased adoption of shaker bottles also spawns evolving consumer desire for variety, broadened functionality, and increased efficiency. For example, some users want to increase the variety of their drinks and supplements by adding food ingredients like fruits (e.g. bananas), vegetables (e.g., avocado), thick dressings, and/or cake batters.

Unfortunately, contemporary shaker bottles are ill-suited to effectively mix compositions that include solid or even medium-to-high viscosity food ingredients. More particularly, most shaker bottles use free-floating agitator or fixed separator designs with frameworks and voids for mixing ingredients. In large part, these designs were engineered to adequately mix low viscosity liquids (like water, milk, or juice) with one or more powdered supplements. Free-floating agitators are too lightweight and have too much drag to achieve the momentum necessary to mix solid ingredients or those resulting in a higher mass, viscosity, and/or volume within the container. Additionally, the efficacy of fixed separators to mix such ingredients is limited by separator positioning and design, container fill level and travel, and other variables. Accordingly, attempts to mix the type of ingredients mentioned above in contemporary shaker bottles results in a chunky, poorly mixed messes that may not make it through the lid for user consumption, or, even if they do fit through the lid, must be chewed by a user for consumption.

What is needed is a new category of mixing device for shaker bottles that is capable of effectively mixing denser food ingredients through the traditional shake and drink methods shaker bottle users are accustomed to. Such a mixing device would dramatically expand mixed-drink types for users without having to resort to the powered and other mixer types typically required.

### SUMMARY OF THE INVENTION

In accordance with the above, a new mixing device is provided comprising: a generally dumbbell-shaped agitator insertable within a hand-held, shakeable container and composed of a framework arranged to provide voids to allow for flow of liquids, powders, and other materials into and out of portions of the generally dumbbell-shaped agitator; and a weighted member attached adjacent to the center of the generally dumbbell-shaped agitator.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is an exploded view of one embodiment of a mixing device with a container, agitator, and weighted member.

FIG. 2 is a side view of a second embodiment of a mixing device with an agitator and weighted member.

FIG. 3 is a side, exploded view of a second embodiment of a mixing device with an agitator and weighted member.

FIG. 4 is a side, cross-section view of a second embodiment of a mixing device with an agitator and weighted member.

FIG. 5 is a front view of a third embodiment of a mixing device with weighted member.

FIG. 6 is a back view of a third embodiment of a mixing device with weighted member.

FIG. 7 is a side view of a third embodiment of a mixing device with weighted member.

FIG. 8 is a front view of a third embodiment of a mixing device with weighted member.

FIG. 9 is a back view of a third embodiment of a mixing device with weighted member.

FIG. 10 is a side view of a third embodiment of a mixing device with weighted member.

FIG. 11 is a side view of a fourth embodiment of a mixing device with an agitator and weighted member.

FIG. 12 is a side, cross-section view of a fourth embodiment of a mixing device with an agitator and weighted member.

FIG. 13 is a first perspective view of a fifth embodiment of a mixing device with weighed member.

FIG. 14 is a second perspective view of a fifth embodiment of a mixing device with weighted member.

FIG. 15 is a first side view of a fifth embodiment of a mixing device with weighted member.

FIG. 16 is a second side view of a fifth embodiment of a mixing device with weighted member.

FIG. 17 is a top view of a fifth embodiment of a mixing device with weighted member.

### DETAILED DESCRIPTION OF THE ILLUSTRATED EMBODIMENT

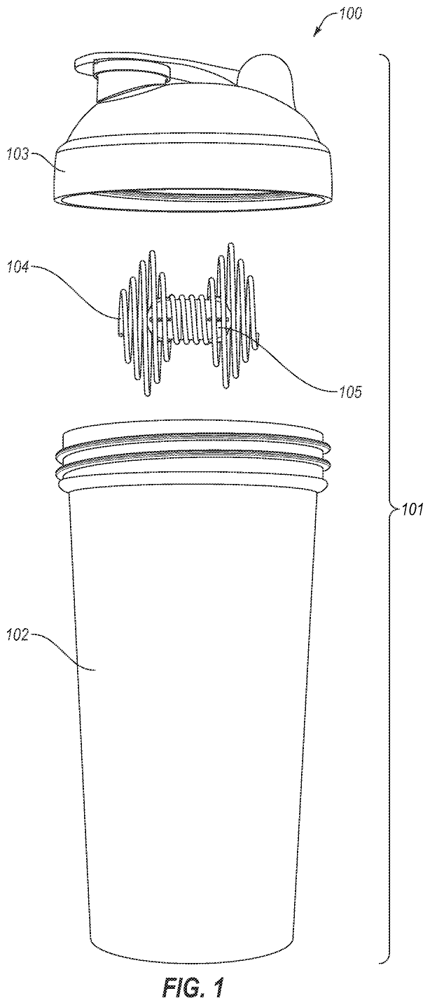

The present invention in its various embodiments, some of which are depicted in the figures herein, is a mixing device. Referring now to FIG. 1, a first embodiment of a mixing device 100 is shown. This mixing device 100 may include a container 101 for holding liquids comprising a lower cup or bottle portion 102 and releasably attachable lid portion 103. Container 101 is configured to be hand-held and shakable. The mixing device 100 may also include a dumbbell-shaped agitator 104 that is insertable within the container 101 and composed of a framework arranged to provide voids to allow for the flow of liquids, powders, and other materials, such as, for example, fruit and vegetable pieces, into and out of portions of the agitator 104. Mixing device 100 includes a weighted member 105 that is releasably attached to the agitator 104 adjacent to or within the center of the agitator 104. In other embodiments, the mixing device 100 may omit the container 101, but include the agitator 104 and weighted member 105. In still other embodiments, the mixing device 100 may omit both the container 101 and the agitator 104 and include only the weighted member 105.

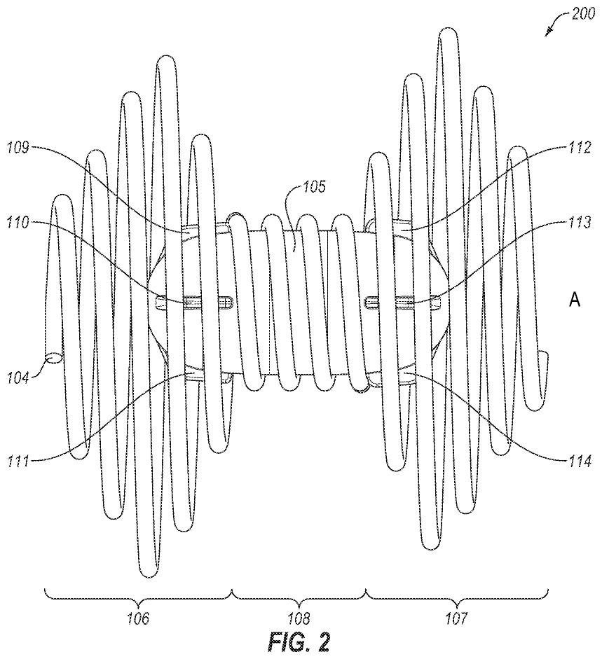

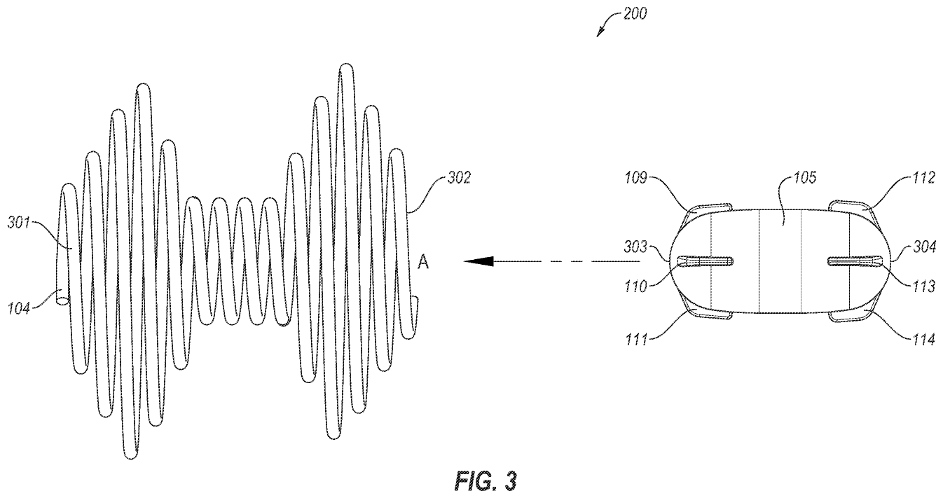

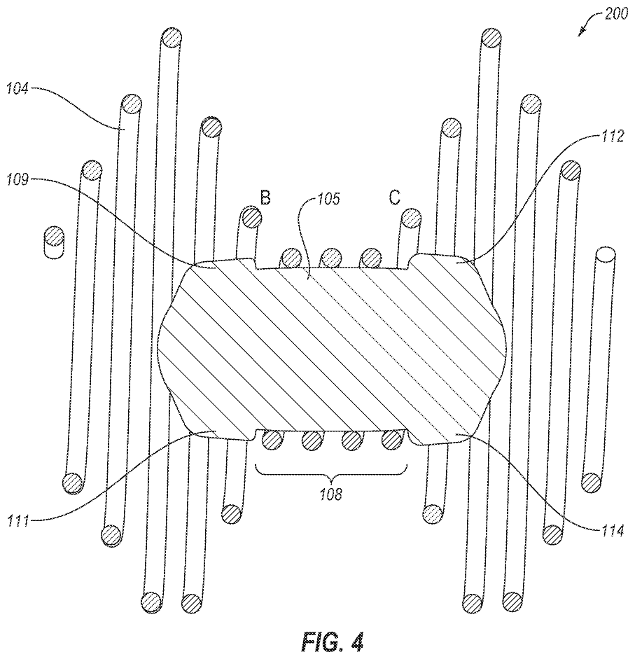

Referring now to FIGS. 2 through 4, in the illustrated embodiment, dumbbell-shaped agitator 104 may be a type of compressible, spiraled spring structure. Dumbbell-shaped agitator 104 has first 106 and second 107 ends with a connecting portion 108 in between. First 106 and second 107 ends generally have larger diameters than the connecting portion 108. Dumbbell-shaped agitator 104 may also have a central passageway A within the connecting portion 108. Agitator ends 106, 107 extend beyond weighted member ends to prevent and/or reduce weighted member 105 impacts against the container interior when the mixing device is being shaken by a user. Agitators may have weight ranges of between around 15 grams to around 30 grams.

In preferred embodiments, weighted member 105 is not comprised of detachable parts and does not have voids. Rather, weighted member 105 is a single, solid piece constructed of, for example, metal, plastic, or other suitable material. Simplified single-piece construction makes the mixing device easy to clean and resistant to parts breakage and resulting choking/safety concerns. Weighted member 105 may be, e.g., torpedo-shaped, oblong, spheroid, ellipsoid, rectangular, cylindrical and/or elongate. Weighted member 104 may also have one or more ends 303, 304 that are narrower than a middle portion of the weighted member to achieve a streamlined shape.

One or more retention members 109, 110, 111, 112, 113, 114 are disposed on weighted member 105, the retention members outwardly extending, and configured to retain the weighted member 105 within the agitator 104 and/or central passageway A. Across embodiments, retention members may vary in number or orientation. For example, weighted member 105 may have a first end 303 with one or more retention members 109, 110, 111 and a second end 304 with one or more retention members 112, 113, 114. The weighted member of the illustrated embodiment has first and second sets of four equidistant retention members, each retention member oriented parallel to a longitudinal axis of the weighted member 104. Combining a streamlined weight with such retention members increases mixing device velocity and enhances mixing effectiveness. Retention members may have generally sloping or generally right angle leading or trailing edges to facilitate or act against insertion and/or removal. In preferred embodiments, the weighted member 105 has an overall weight of between 20 grams and 35 grams.

Weighted member 105 is insertable into agitator central passageway A through first 301 and/or second 302 agitator apertures respectively adjacent to first 106 and/or second 107 agitator ends. Insertion is accomplished with some application of force and a small diameter expansion of the central passageway A due to yield in the connecting portion 108. Once pushed into and centrally positioned within the agitator 104, central passageway A contracts and retention members 109, 110, 111 create a first fixed catch to retain the weighted member 105 adjacent to central passageway first end B; other retention members 112, 113, 114 create a second fixed catch to retain the weighted member 105 adjacent to central passageway second end C.

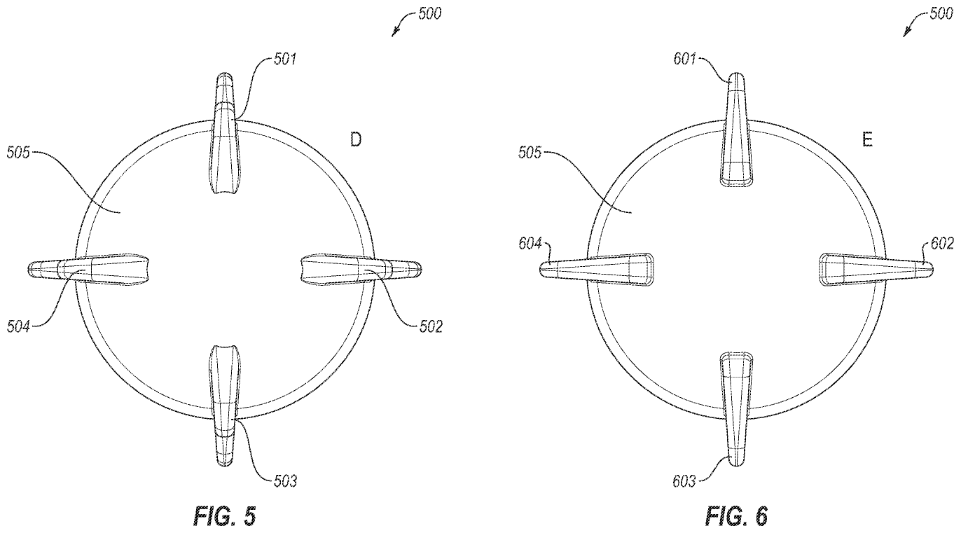

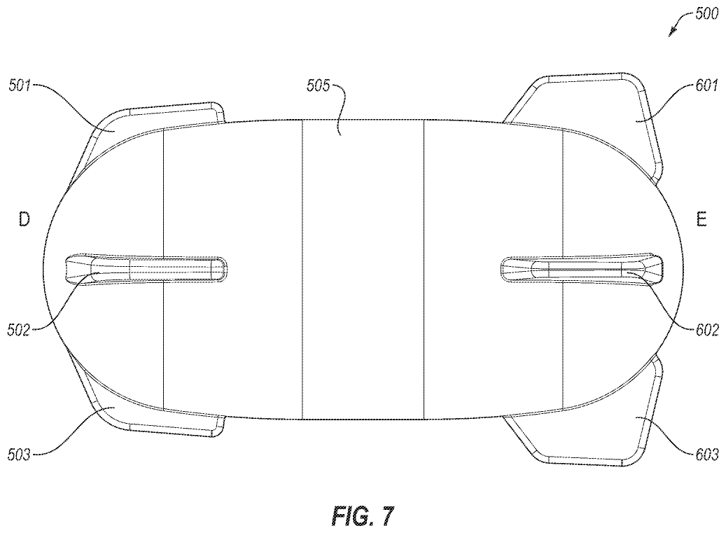

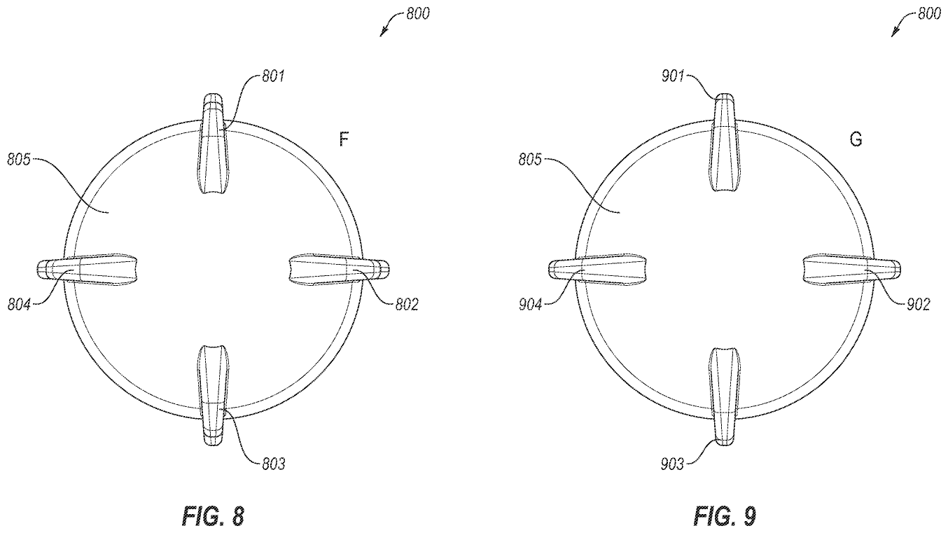

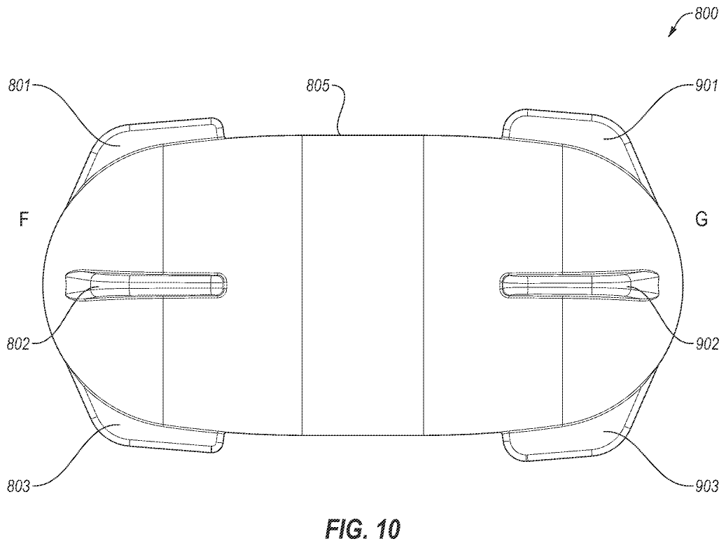

Referring briefly to FIGS. 5-10, various embodiments of the mixing device and/or weighted member are shown in more detail. In the embodiment of FIGS. 5 through 7, the weighted member 500 has a first set of four equidistant retention members 501, 502, 503, 504 adjacent a first end D of the weighted member 500 and a second set of four equidistant retention members 601, 602, 603, 604 adjacent a second end E of the weighted member 500. Similarly, in the embodiment of FIGS. 8-10, the weighted member 800 has a first set of four equidistant retention members 801, 802, 803, 804 adjacent a first end F of the weighted member 800 and a second set of four equidistant retention members 901, 902, 903, 904 adjacent a second end G of the weighted member 800. The number, positioning, and spacing of retention members or equivalent structures may vary without departing from the purpose and scope of the invention. For example, in FIGS. 1-10, retention members may be alternatively characterized as fins in their configuration; however, as described below, other embodiments have retention members of different configuration.

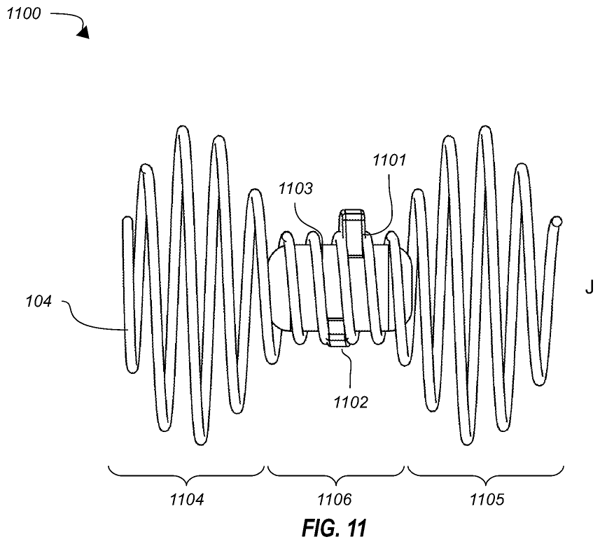

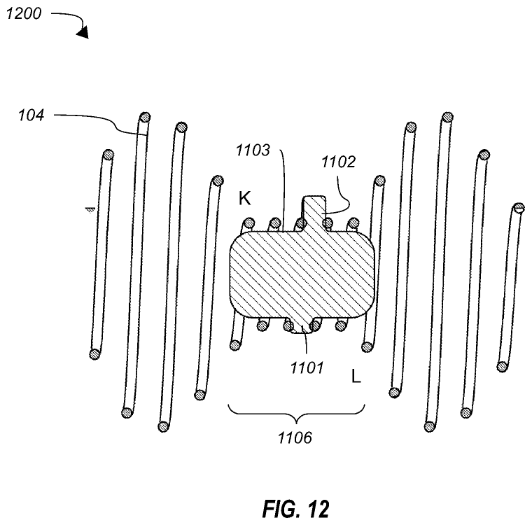

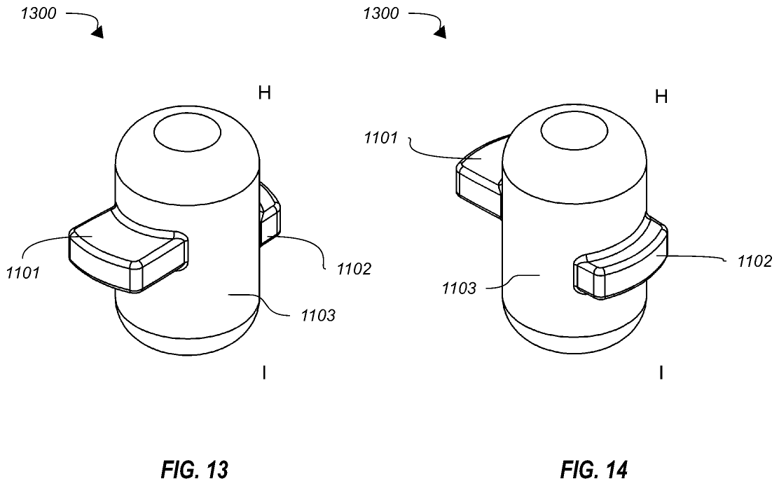

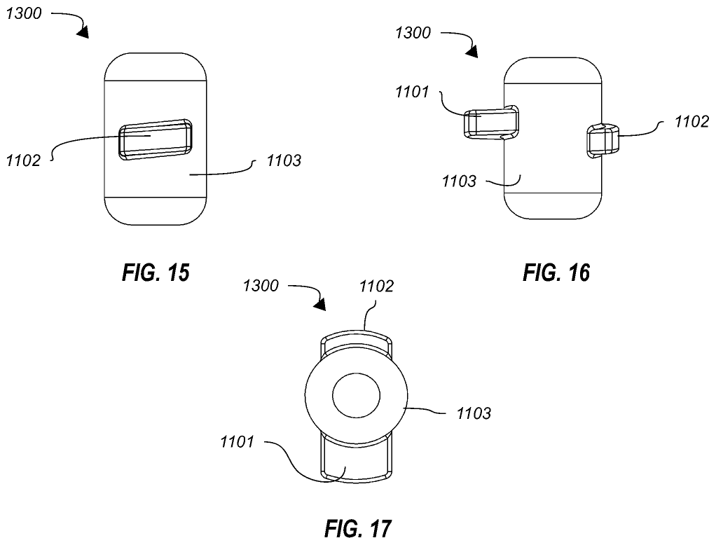

Referring now to FIGS. 11-17, additional embodiments of the mixing device and/or weighted member are shown in more detail. Such embodiments may include dumbbell-shaped agitator 104 with first 1104 and second 1105 ends and a connecting portion 1106 in between. First 1104 and second 1105 ends generally have larger diameters than the connecting portion 1106. Dumbbell-shaped agitator 104 may also have a central passageway J within the connecting portion 1106 configured to releasably retain a weighted member 1103. Agitator ends 1104, 1105 extend beyond weighted member ends to prevent and/or reduce weighted member impacts against the container interior when the mixing device is being shaken by a user. Agitators may have weight ranges of between around 15 grams to around 30 grams.

In the embodiment of FIGS. 11 through 17, weighted member 1103 has first 1101 and second 1102 opposing retention members located on a side between first H and second I ends of the weighted member 1103. Retention members 1101, 1102 may be generally perpendicular to a longitudinal axis of the weighted member 1103. Retention members may be co-elevational or, alternatively, located at different elevations with respect to a longitudinal axis of the weighted member. Retention members may also differ in length, for example, in distal length with respect to a side of the weighted member. Retention members may also be slightly angled with respect to perpendicular to a longitudinal axis of the weighted member in order to achieve a propeller-type and/or basic threading configuration whereby a user may rotate the weighted member into and/or out of the springs of the agitator. Angles of retention members may be more extreme than those of adjacent agitator springs to bias the springs for enhanced retention during operation. Significantly, the retention members of this embodiment are also centrally located to facilitate a weighted member configuration that is optimally recessed from agitator ends to prevent the weighted member from damaging a container when in operation. Again, the number, positioning, and spacing of retention members or equivalent structures may vary without departing from the purpose and scope of the invention.

So configured, mixing device provides optimized mixing capability through a unique structure—for example, with opposing spring agitator frameworks joined by a streamlined weight—that also enhances mixing device momentum (or mass times velocity achieved by a user's shaking). This increases the effectiveness of the mixing device for mixing things like protein powder supplements, but also widens the range of mixable material for such a device to include, for example, ingredients like banana, avocado, thick dressings, thick cake batters.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A mixing device comprising:
a generally dumbbell-shaped agitator insertable within a hand-held, shakeable container and composed of a framework arranged to provide voids to allow for flow of liquids, powders, and other materials into and out of portions of the generally dumbbell-shaped agitator; and
a weighted member attached adjacent to the center of the generally dumbbell-shaped agitator.

2. The mixing device of claim 1, the weighted member further comprising only a single piece.

3. The mixing device of claim 1, the weighted member further formed as a substantially solid piece without voids.

4. The mixing device of claim 1, the generally dumbbell-shaped agitator having ends that extend beyond weighted member ends.

5. The mixing device of claim 1, the weighted member further having a first set of retention members oriented perpendicular to a longitudinal axis of the weighted member.

6. The mixing device of claim 5, the first set of retention members configured to retain the weighted member within the generally dumbbell-shaped agitator.

7. The mixing device of claim 1, the weighted member further having a first set of retention members oriented parallel to a longitudinal axis of the weighted member.

8. The mixing device of claim 7, the weighted member further having a second set of retention members oriented parallel to a longitudinal axis of the weighted member.

9. The mixing device of claim 7, the first set of retention members configured to retain the weighted member within the generally dumbbell-shaped agitator.

10. The mixing device of claim 8, the second set of retention members configured to retain the weighted member within the generally dumbbell-shaped agitator.

11. The mixing device of claim 1, the weighted member having one or more ends narrower than a middle portion of the weighted member for streamlining.

12. The mixing device of claim 1, the weighted member releasably attachable to the generally dumbbell-shaped agitator.

13. The mixing device of claim 1, the framework further comprising compressible spring ends that extend beyond weighted member ends, the compressible spring ends configured to generally prevent the weighted member from striking a shakeable container interior when the mixing device is in operation.

14. A mixing device comprising:
a generally dumbbell-shaped agitator insertable within a hand-held, shakeable container and composed of a framework arranged to provide voids to allow for flow of liquids, powders, and other materials into and out of portions of the generally dumbbell-shaped agitator; and
a weighted member attached adjacent to the center of the generally dumbbell-shaped agitator and further comprising only a single, substantially solid piece without voids.

15. The mixing device of claim 14, the generally dumbbell-shaped agitator having ends that extend beyond weighted member ends.

16. The mixing device of claim 14, the weighted member further having a first set of retention members oriented perpendicular to a longitudinal axis of the weighted member.

17. The mixing device of claim 16, the first set of retention members configured to retain the weighted member within the generally dumbbell-shaped agitator.

18. The mixing device of claim 14, the weighted member further having a first set of retention members oriented parallel to a longitudinal axis of the weighted member.

19. The mixing device of claim 18, the weighted member further having a second set of retention members oriented parallel to a longitudinal axis of the weighted member.

20. The mixing device of claim 18, the first set of retention members configured to retain the weighted member within the generally dumbbell-shaped agitator.

21. The mixing device of claim 19, the second set of retention members configured to retain the weighted member within the generally dumbbell-shaped agitator.

22. The mixing device of claim 14, the weighted member having one or more ends narrower than a middle portion of the weighted member for streamlining.

23. The mixing device of claim 14, the weighted member releasably attachable to the generally dumbbell-shaped agitator.

24. The mixing device of claim 14, the framework further comprising compressible spring ends that extend beyond weighted member ends, the compressible spring ends configured to generally prevent the weighted member from striking a shakeable container interior when the mixing device is in operation.

25. A mixing device comprising:
a container for holding liquids, the container configured to be hand-held and shakeable;
a generally dumbbell-shaped agitator insertable within the container and composed of a framework arranged to provide voids to allow for flow of liquids, powders, and other materials into and out of portions of the generally dumbbell-shaped agitator; and
a weighted member releasably attached adjacent to the center of the generally dumbbell-shaped agitator and comprising only a single, substantially solid piece without voids and having two or more retention members oriented perpendicular to a longitudinal axis of the weighted member configured to retain the weighted member within the generally dumbbell-shaped agitator;
the framework further comprising compressible spring ends that extend beyond weighted member ends, the compressible spring ends configured to generally prevent the weighted member from striking a shakeable container interior when the mixing device is in operation.
